(19) United States
(12) Patent Application Publication
(10) Pub. No.: US 2018/0140880 A1
(43) Pub. Date: May 24, 2018

(54) High Pressure Fire Extinguisher

(71) Applicant: Key Safety Systems, Inc., Sterling Heights, MI (US)

(72) Inventors: Sergio Rea, Colleferro (IT); Matthias Volkmann, Kronberg (DE); Gregor Gromodka, Frankfurt am Main (DE)

(73) Assignee: Key Safety Systems, Inc., Sterling Heights, MI (US)

(21) Appl. No.: 15/518,091

(22) PCT Filed: Oct. 12, 2015
(86) PCT No.: PCT/US15/55127

§ 371 Date: Apr. 11, 2017

Related U.S. Application Data
(60) Provisional application No. 62/062,911, filed on Oct. 12, 2014.

(51) Int. Cl. A62C 35/13; A62C 35/02; A62C 37/40

(52) U.S. Cl. CPC A62C 35/13; A62C 13/006; A62C 37/40; A62C 35/023

(57) ABSTRACT

A system (23, 300) including a fire extinguishing apparatus capable of delivering a high velocity stream of fluid and fire extinguishing agent, both the fluid and agent directed toward the fire, the apparatus comprising:
at least an outer first tube (100, 34) having a first end and a second end, the first tube having a predetermined length L, inner diameter and outer diameter,
an air permeable tube, hose or sack (120, 350) positioned inside of the first tube, the sack having a first tube end and a second tube end; the sack extending from a first position along first tube end to a second position along the first tube and terminating close to or at the second end of the first tube;
fire extinguishing agent (160) located between the permeable tube and the inner diameter of the first tube;
a dislodgable plug or breakable disk secured to the second end of the first tube to prevent contaminants from entering the first tube;
a source of high pressure fluid (180) connected directly or indirectly such as through a manifold to the first end of the first tube, the source configured to deliver the high pressure fluid upon receipt of an activation signal causing pressurizing fluid to enter the first end of the sock, the gas flow causing the plug to dislodge and flowing out of the sock to push the fire extinguishing material out the now open second end of the first tube.

### BACKGROUND AND SUMMARY OF THE INVENTION

The present invention provides an improved fire extinguishing apparatus and method of operation.

The present invention provides the following benefits and advantages over prior art fire extinguishing systems. The present invention uses as at least one pressure source a gas generator proven to maintain its pressurized fluid for at least 10-15 years. The system provides a wide dispersion of fire extinguishing.

More particularly, the invention comprises: a system including a fire extinguishing apparatus capable of delivering a high velocity stream of fluid and fire extinguishing agent, both the fluid and agent directed toward the fire, the apparatus comprising: at least a first tube having a first end and a second end, the first tube having a predetermined length L, inner diameter and outer diameter, an air permeable, flexible tube, hose, sack, tube, pocket positioned inside of the first tube, the sack, hose, tube or pocket having a first tube end and a second tube end; the sack extending from a first position along first tube end to a second position along the first tube and terminating close to or at the second end of the first tube; a fire extinguishing agent located between the sack and the inner diameter of the first tube; in its initial conditions the hose, tube, sack etc. is flat, a dislodgable or breakable plug secured to the second end of the first tube to prevent contaminants from entering the first tube; a source of high pressure fluid connected directly or indirectly such as through a manifold to the first end of the first tube, the source configured to deliver the high pressure fluid upon receipt of an activation signal causing pressurizing fluid to enter the first end of the hose, tube, pocket, sock or sack, the gas flow causing the plug to dislodge and flowing out of the hose to push the fire extinguishing material out the now open second end of the first tube. The terms hose, tube, sack, sock and pocket are used interchangeably.

### BRIEF DESCRIPTION OF THE DRAWINGS

FIG. 1 diagrammatically illustrates a fire extinguishing system of the present invention.

FIG. 2 shows a few of the major components of the present invention.

FIG. 2a shows end views of an outer tube and inner tube or sack, sock or pocket.

FIG. 2b is a plan view showing a part of the inner tube or sack placed over an end of the outer tube.

FIG. 3 shows a cross-section of an alternate stainless steel tube.

FIGS. 4, 4a, and 4b show the steps used in making one of the socks that can be used as part of the present invention.

FIG. 4c shows the inner tube or sock in the outer tube with an end of the sock placed about an end of the outer tube.

FIG. 4d shows a manifold or piece of a manifold about to be pushed into the outer tube and sock.

FIG. 4e shows the sock secured in the outer tube.

FIG. 5 shows the outer tube and sock or hose in a vertical orientation.

FIG. 6 shows granules of fire extinguishing material in the tube.

FIG. 6a is a cross-sectional view taken through section 6a-6a of FIG. 6.

FIG. 7 shows a typical manifold.

FIG. 7a shows a gas inflator attached to an inlet of the manifold.

FIG. 7b shows a plurality of outer tubes and socks attached to the manifold of FIG. 7.

FIG. 7c shows another embodiment of the invention using a plurality of gas generators/gas inflators.

FIG. 7d includes a controllable solenoid in another embodiment.

FIG. 8 shows the details of a prior art gas generator that can be used with the present invention.

FIG. 9 shows a method of terminating the exit end of a metal tube.

FIG. 9a separately shows each of the elements of FIG. 9.

FIGS. 10, 10a, 10b and 10c show another way of terminating the exit end of a plastic outer tube.

FIG. 11 shows an exemplary installation of a fire extinguishing system in a typical vehicle engine compartment.

FIG. 11a shows a fire extinguishing system installed in a cabinet which can take many configurations.

FIG. 12 shows an alternate embodiment of the invention.

FIG. 13 shows an enlarged view of a manifold in the shape of a T-connection.

FIG. 14 is an alternate representation of FIG. 12 with an external or outer protective tube or housing removed from one side of the system.

FIG. 15 is an enlarged view of a portion of FIG. 14.

FIG. 16 is an enlarged view of an end of an internal, flexible, permeable tube or hose.

FIGS. 17 and 18 show how one end of the permeable hose, tube, sock, sack or pocket is secured to a manifold.

FIG. 19 shows a segmented ring.

FIG. 20 shows how one terminal end of the system is formed.

FIG. 21 shows how an outer metal tube is secured to a manifold.

FIG. 22 is a cross-sectional view showing the fire extinguishing agent, outer and inner hose.

FIG. 23 is a longitudinal cross-sectional view showing the major components at the nozzle end of the outer tube.

### DETAILED DESCRIPTION OF THE DRAWINGS

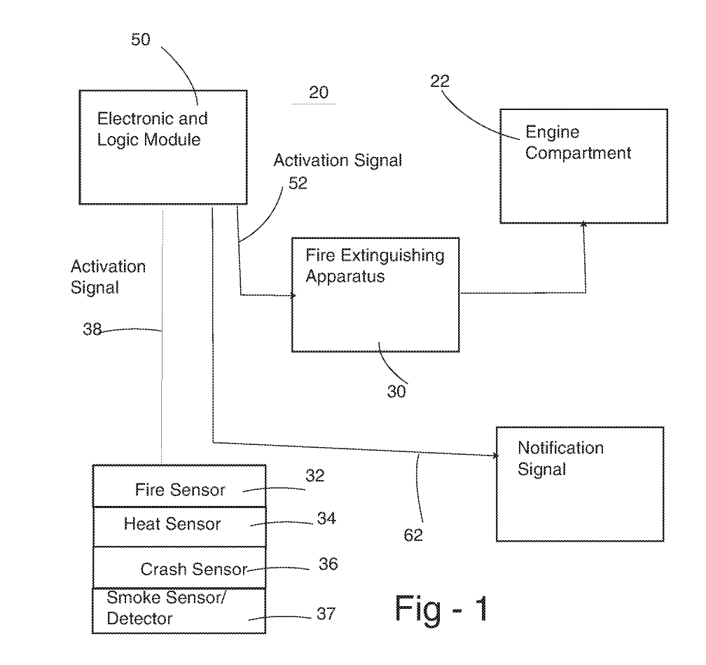

FIG. 1 shows the basic elements of the fire extinguishing system 20 utilizing the teachings of the present invention. In the preferred embodiment system 20 is designed to sense and extinguish a fire within an engine compartment 22 of the vehicle. The present system can be utilized to sense and extinguish fires in buildings, storerooms, file cabinets, electronic storage cabinets, batteries, transformers, servers, library cabinets, museum glass shelf, medicine cabinets and the like.

System 20 comprises a fire extinguishing apparatus 30 which when activated extinguishes a fire such as within the engine compartment 22 (or of the designated location or space). The system comprises one or more sensors such as a fire sensor 32, a heat sensor 34, a crash sensor 36, and/or smoke sensor or detector 37 each of which can generate an activation signal 38 which is communicated to an electronics and logic module 50. When an existing or soon to begin fire is sensed or anticipated by the electronic and logic module 50 and sensors, module 50 generates an activation signal 52 to initiate fire suppression by the fire extinguishing apparatus 30. The system 20 may also send a communication signal 62 through a communications device 60 which is part of the vehicle (location or space with the fire suppression apparatus) to notify the police or fire department of the fire.

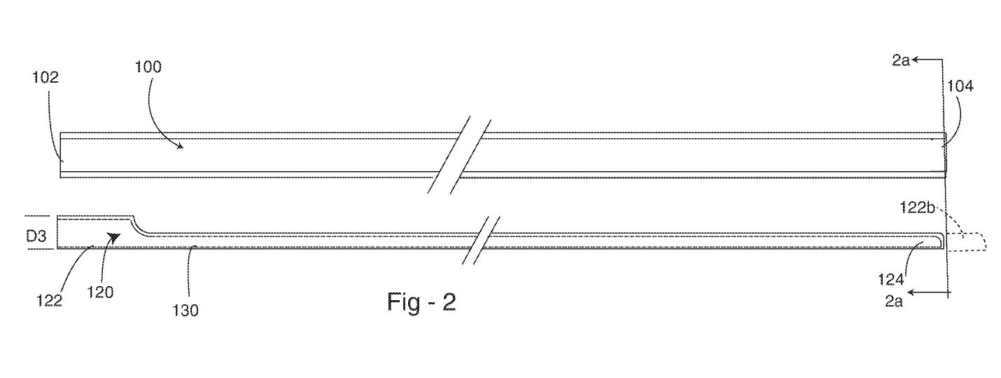

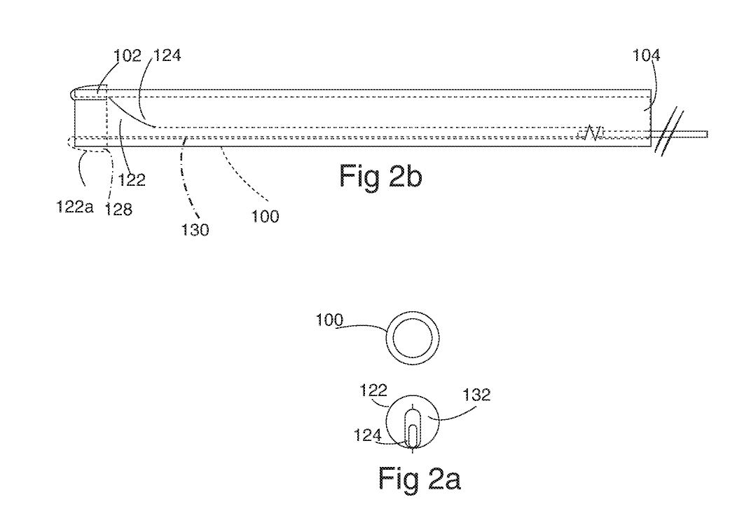

FIG. 2 shows some of the major components of the present invention: a tube, sack, hose or pocket 120 (sack or pockets are used interchangeably). The outer hose or tube 100 preferably has flexible walls. For example, hose or tube 100 can be made of metal, or plastic such as a self-fire-extinguishing plastic that could also incorporate a fiberglass-filled nylon or metal including stainless steel corrugated tube. Tube 100 includes open ends 102 and 104. The preferred “internal” tube diameter D3 for automotive applications falls in a range of about 25-28 mm with the presently preferred internal diameter of about 20 mm. In general, the external tube diameter is determined by the material and/or technology used to produce the tube. If the tube is plastic or stainless coiled steel, the outside diameter for both is in the range of 25-28 mm. Stainless steel shows less degradation in an engine environment than most other materials.

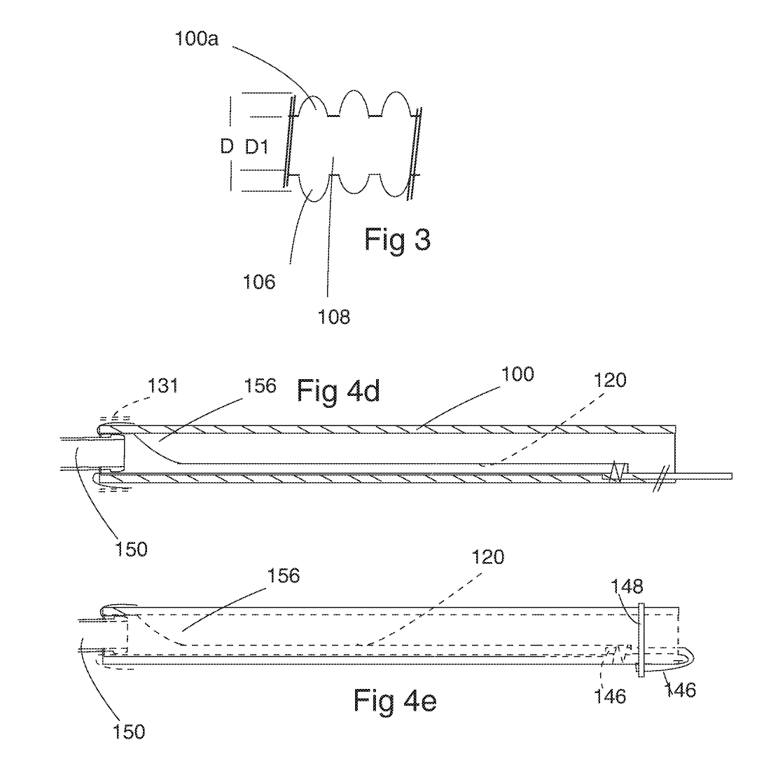

The outer hose or tube 100 shown in FIG. 2 has straight sides which is representative of most tubular material. FIG. 2a is an end view of the outer tube and the inner hose, sack (pocket). Outer tube 100 at least in parts can be circular in shape. The oval shape of part of the inner hose, tube or sock is to emphasize that most of the hose, sock 120 once placed within the tube will lie flat. We have determined for our invention a stainless steel coiled tube also referred to as a corrugated tube 100a with parallel corrugations or waves 106, joined by a constant tubular section 108 as shown in FIG. 3, shows improved performance. In this configuration the diameter D of the wave portion 106 is about 3-7 mm. while the diameter D1 of the constant tubular section is about 20-28 mm. As will be appreciated from the discussion below, a greater amount of fire extinguishing powder or agent can be packed into tube 100a than in tube 100, that is, for the same length of tubing. As mentioned above, stainless steel is a preferred choice of tube material as it displays lower degradation in an engine compartment than many other materials. Alternative material tube could be plastic, steel, iron, reinforced rubber, even copper or other metals. This tube construction can be replaced by a standard metal corrugated tube.

The second major component is an air permeable inner hose, sock, pocket or sack 120 with ends 122 and 124. The degree of permeability of the inner hose is to prevent the fire extinguishing material from readily entering the pocket. The present choice of material for the sack or pocket is uncoated woven material. One suitable material has the following characteristics: thread size PA6.6, 235 dtex, uncoated; with a fabric weave density warp and weft 285+/−15 per dm.

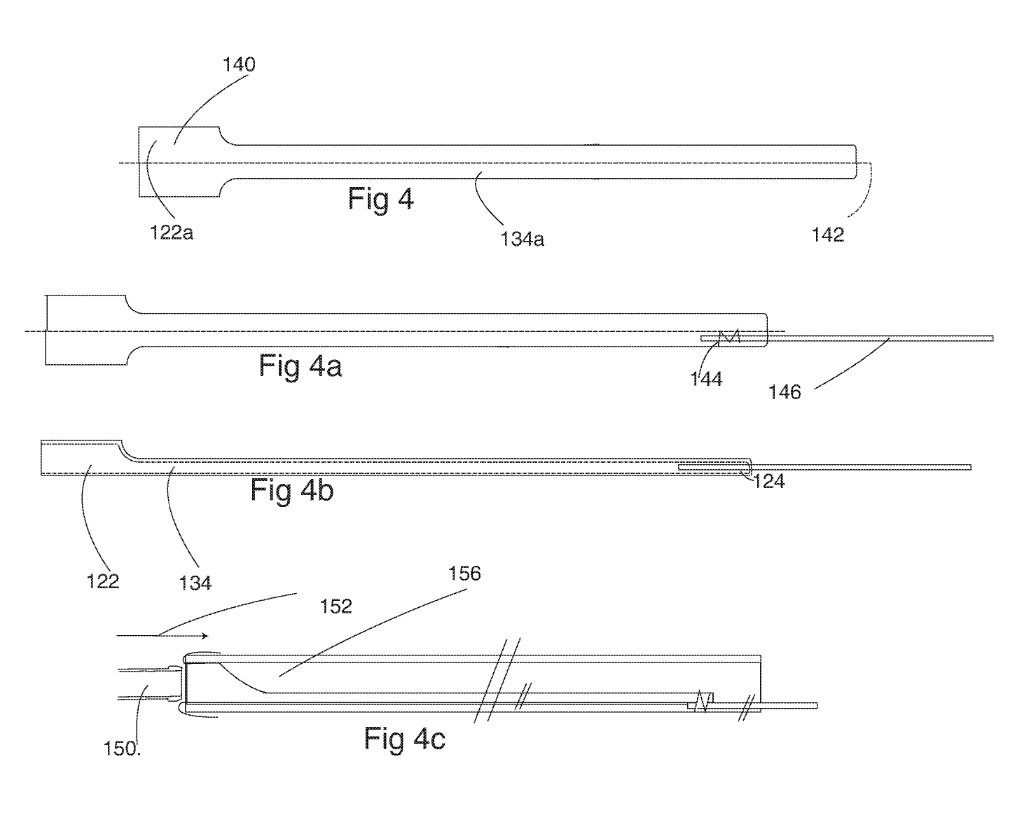

The length of the inner tube or sack 120 can be shorter than that of the outer tube 100, the same length or even longer than the tube 100. In FIG. 1 the inner hose or sack and outer tube are shown substantially of equal length; FIG. 1 also shows a longer inner hose or sack with dotted lines 120b, and FIG. 4d shows an inner tube or sack that is shorter than the tube. End 122 and a short section of the pocket 120 have a wider diameter than most of the remaining narrower portion 132 of the pocket 120. The diameter D3 is sufficiently large to permit end 102 to be rolled over and placed upon end 102 as shown in for example FIGS. 4c and 4d. A transition surface 124 shows the transition from the wide portion 122 to the narrow portion 132 of the inner or tube. In FIG. 2b, the rolled end of the inner hose, sack (pocket) is shown as 122a. An optional layer of adhesive 128 is shown in dotted line, under the rolled-over portion 122a of the pocket 120 to create a secure connection with the outer tube. Returning briefly to FIG. 2a, once the inner hose end 122 is placed about end 102 of the outer tube its shape will be that of the exterior of the outer tube. In the case of FIG. 2a, this shape is circular. As mentioned when the inner hose or sock 120 is placed in the outer tube the narrow portion 132 which is the greater length of the inner hose 120 will tend to be flat. When the outer tube is filled with fire extinguishing material the narrow portion 132 will lie flat and a large portion of the transition portion will be also lie flat. An end clamp 131 can also be used to secure the sack to the inner hose tube, this clamp is shown in phantom line in FIG. 4d.

As seen in many of the figures the inner tube or sock 120 includes a connecting joint which is a sewn seam 134. Depending on the chosen inner hose or sock material this joint can be a weld or heat joint. As can also be seen the sewn seam or joint closes the narrow portion 132 of the sock 120 at its end 124. FIG. 4 shows a panel of woven material 140 formed or otherwise cut into the shape as shown. When laid flat the material will have a wide end 122a and a narrow portion 132a. The centerline 142 of the material also serves as a fold line. In FIG. 4a, a rope or thin piece of woven material 146 or rolled or small cut folded section of the material as used for the inner tube 140 is shown sewn to the material 140 by seam 144. The material 140 is then folded over at the centerline (fold line) to achieve the shape shown in FIG. 4b. Thereafter the two halves of the material are sewn or otherwise joined together at joint 130 to form the inner tube or hose.

Reference is again made to FIG. 4c. As previously mentioned this figure shows the inner hose or sock 120 placed in the outer tube 100. The following is one way of achieving this. The inner hose or sock is slid down the outer tube until the inner tube is positioned as shown in FIG. 4c. With the inner hose or sock 120 positioned as shown FIG. 4c, the end 122a of the hose or sock 120 is rolled over the end 102 of the outer tube, as previously mentioned. To maintain the wide portion 122 of the inner hose or sock secured to end 102 of outer tube 100, a manifold 150 is placed into the outer tube. In FIG. 4d the manifold 150 is shown spaced from the outer tube and inner hose or sock. Arrow 152 shows the direction of movement of the manifold as it is moved into the outer tube. In FIG. 4d the manifold 150 has been moved into locking engagement sandwiching an adjacent part of the sock against the inner wall of the outer tube 100. Thereafter the rope is pulled taut, thereby stretching the inner hose or sock 120. The rope 146 is bent over end 104 of the outer tube with the inner tube or sock in tension and secured to the tube. The bent-over portion of rope 146 can be secured permanently or temporarily by a plastic or metal clamp or tie 148. If the outer tube is very long the size of the rope can be increased at least to slightly longer than the outer tube. The rope 146 can be weighted and dropped into the outer tube 100 with the outer tube in a vertical orientation. Thereafter the rope is pulled which moves inner tube or sock 120 into the outer tube and the end of the inner tube or sock placed over the outer tube as shown.

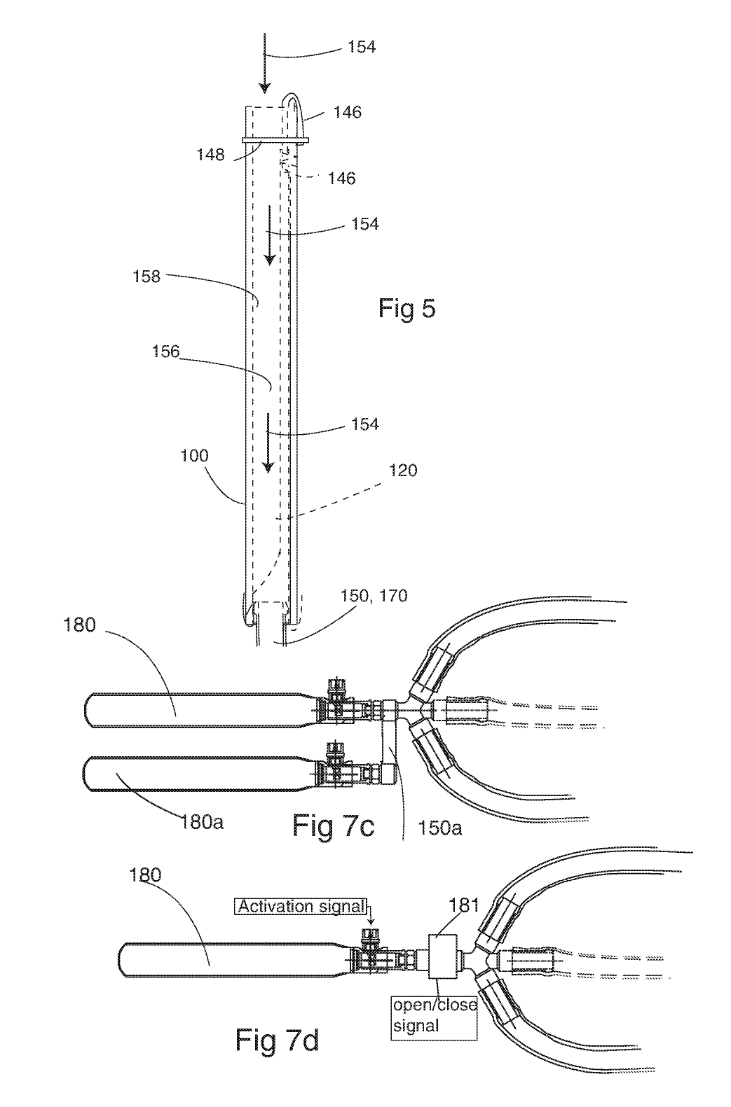

After the inner tube or sock 120 is tensioned in the outer tube the fire extinguishing material 186 is placed in the outer tube. Reference is made to FIG. 5 which shows the configuration of FIG. 4e in a vertical position with the open end 104 upright. Arrow 154 is representative of the fire extinguishing material 186 being placed in the outer tube. The fire extinguishing material 186 will fill the space 156 between the inner tube sock 120 and the inner wall 158 of tube 100 and keep the inner tube in its preferred flattened configuration.

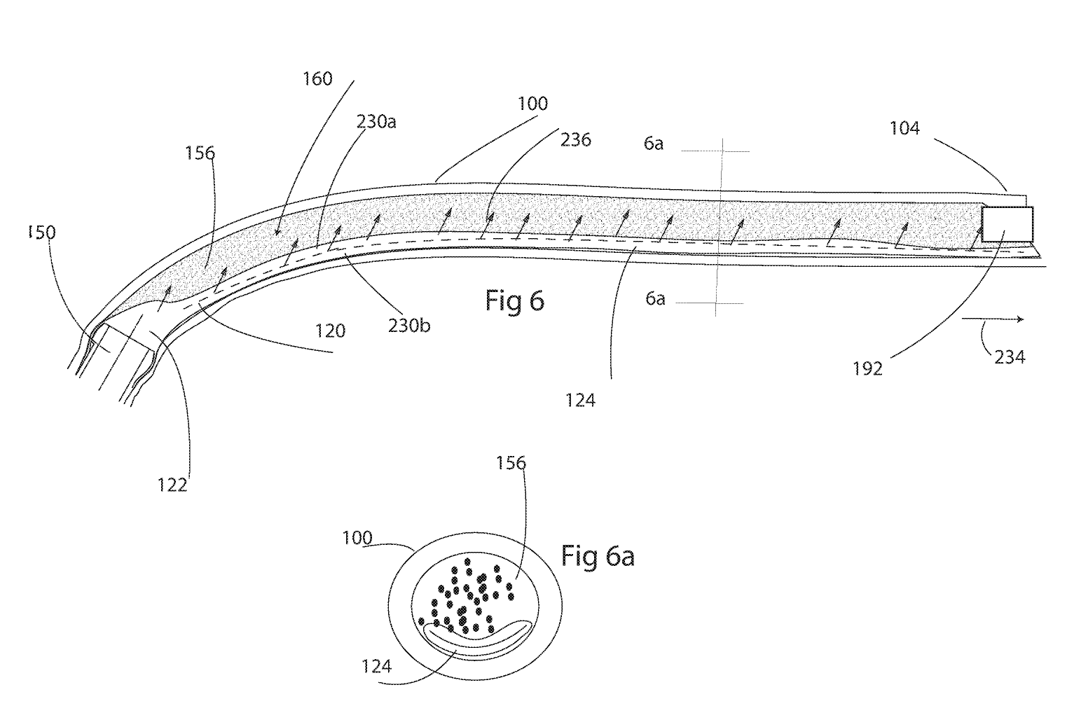

FIG. 6 shows one type of fire extinguishing material 160 filling the space 156 between the inner tube or sock and the outer tube 100. The fire extinguishing material can be granular or liquid (if liquid the inner tube should have a breakable impermeable cover along its length). One type of granular fire extinguishing material usable with the present invention is ABC 40 made by Caldic Furex. If the propellant does not have a constituent to repel water a small amount of silicon can be added for a hydrophobic effect. Alternatively, a desiccant can be added to absorb water. As is known in the art ammonium phosphate is a fire retardant sometimes in a thermoplastic composition.

FIG. 6a is a cross-sectional view through the filled tube 100 and shows the fire extinguishing material compressing the narrow end 124 and a portion of the wider part of the inner tube or sock 120 and filling the space 156.

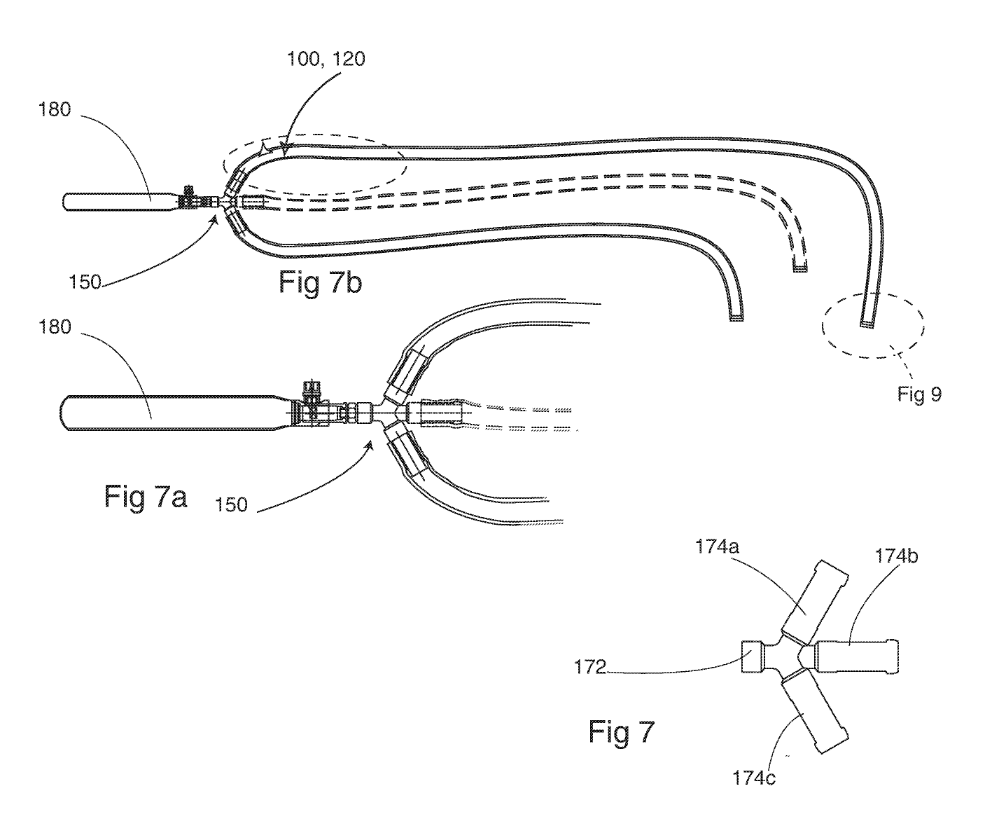

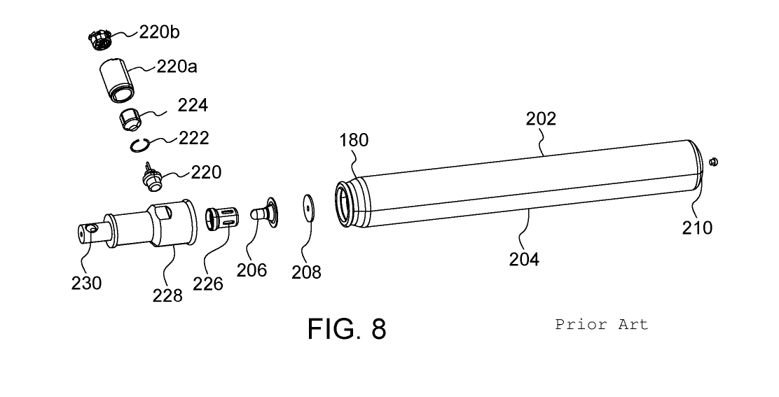

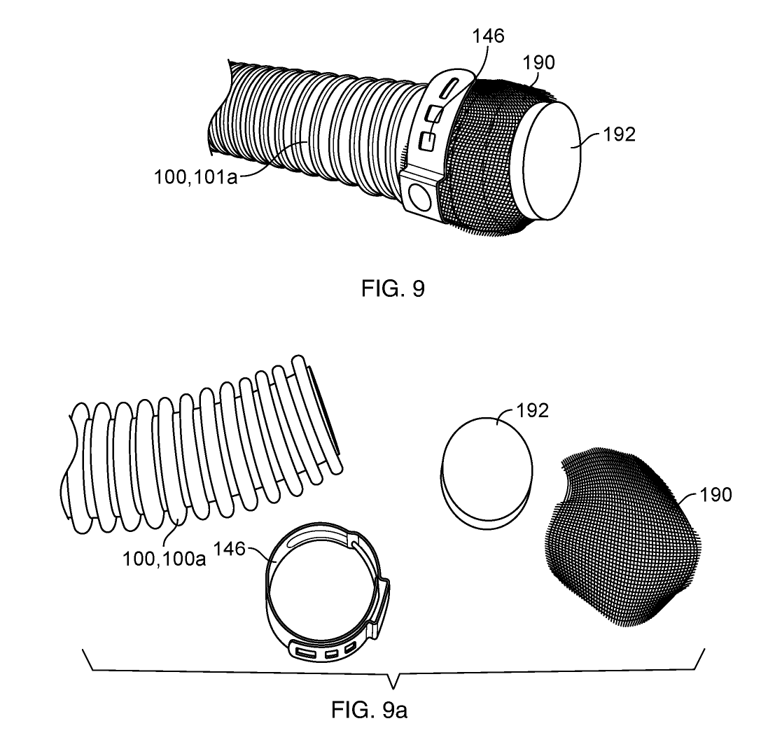

FIG. 7 shows a multiport manifold 170 having a single inlet 172 and a plurality of outlets 174a, 174b and 174c. In FIGS. 4d and 4e a simple manifold 150 with a single inlet and outlet was shown. The manifolds 150 and 170 are functionally equivalent. In FIG. 7a, a gas generator 180 is secured to the inlet 172. Inlet 172 has an initially enlarged diameter to receive the exit ports of the gas generator 180. The outlets 172a-c includes a bulbous end to enhance sandwiching the end 122 of the sock against the tube. Gas generator 180 is inserted into the inlet 172. The gas generator can be any available electrically ignited gas generator, many of which are used in the airbag and seat belt fields. As mentioned, in the preferred embodiment the gas generator is a cold gas generator in which is stored an amount of pressurized inert gas 204 such as argon, helium, nitrogen or some combination. For use as a part of a fire extinguishing system the stored pressure is about 400 bar with a capacity of delivering about 30 liters of inert gas. Such gas could be 95-97% Argon and 3-5% Helium. As can be appreciated, the level of stored pressure, the amount of stored gas, the gas mixture, the amount of fire extinguishing material will vary with each installation. One such gas generator is shown in FIG. 8. The operation of this type of gas generator is well known. Upon receipt of an activation signal from one or all of the fire, heat, smoke and/or crash sensors, an igniter 220 is activated. Activation of the igniter causes the gas 204 stored in the pressure vessel 202 to flow out of the two oppositely oriented radially flow exit ports 230. The other components of gas generator 180 as shown in FIG. 8 are: closure cap 206, throttle 208, pressure vessel sealing ball 210, shorting clip 220b, igniter housing 220a, retaining ring 222, piston 224, screen 226d, radial flow housing 228, and radial flow exit ports 230. To control the flow of gas into the tubes the throttle can be as simple as a washer with an orifice. It has been found that an orifice size of about 1-1.5 mm provides a controlled flow to the tube.

In order to terminate end 104 of tube 100 and also to secure the rope 146 additional hardware is used which is shown in FIGS. 9 and 9a. If the tube is metal such as a constant diameter stainless steel tube 100 or the wavy tube or corrugated 100a, end 104 is terminated with a screen 190, also made of stainless steel wires, to form a matrix of wires with spacing of about 1.5 mm. The diameter of the screen wires is about 0.2 mm diameter. The screen dimensions of course will vary with choice of fire extinguishing material. The screen generates a wider and longer powder flow and in addition pulverizes any lumps that may have formed in the otherwise granulized fire extinguishing material.

In essence, the screen 190 acts as a filter and pulverizer. Screen 190 is placed in the center of the open tube end 102 and pushed into the tube to create a depression. Ends of the screen are held fast by the rope 146. A silicon plastic cap 192 is pushed into the depression formed by the screen. It has been found that a silicon cap can be held in place sufficiently to protect the fire extinguishing material and when the tube is pressurized it will dislodge quickly to prevent the build-up of pressure. The silicon cap 192 can be used for plastic or metal tubes. If desired the remote end 104 of the tube 100 or 100a can be metal-formed into a narrower diameter than that of the center of tube thereby creating a narrow exit nozzle (not shown).

The fire extinguishing system 20 shown in FIGS. 7a and 7b uses two tubes. A third is shown in dotted line. Obviously if only two tubes 100 are desired the manifold 170 would only have three exits or the middle exit of the three exits shown would be blocked. FIG. 7c shows another embodiment of the invention including a plurality of generators/inflators 180 and 180a joined by a manifold 150a. The generator/inflator can be operated together or the secondary inflators activated in case the fire reignites. FIG. 7d shows a generator/inflator 180 communicating to a control valve such as a controllable solenoid 181. When a fire is sensed the solenoid will be in an open condition allowing the fire to be terminated. When the sensors indicate the fire has been quenched the solenoid 181 is closed. If the fire reignites the solenoid is open to permit the fire extinguishing material to once again quench the reignited fire.

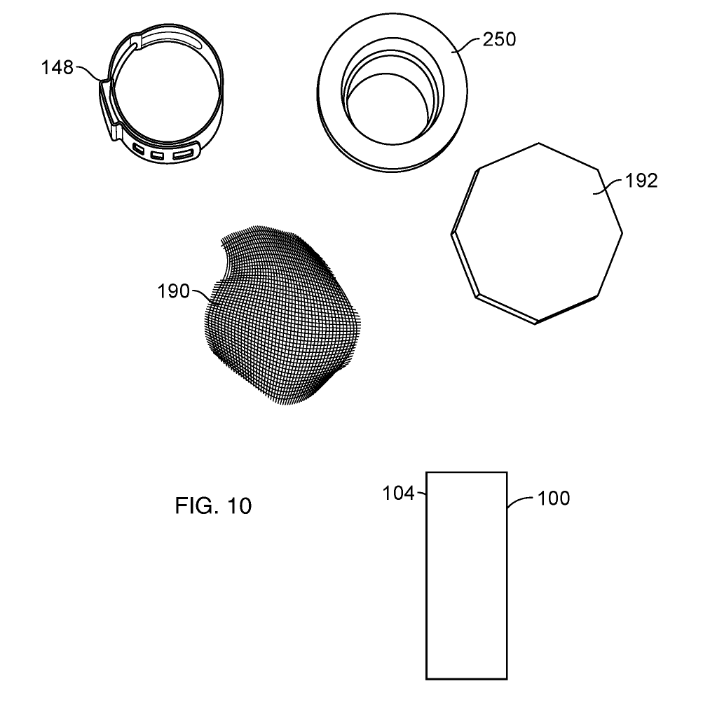

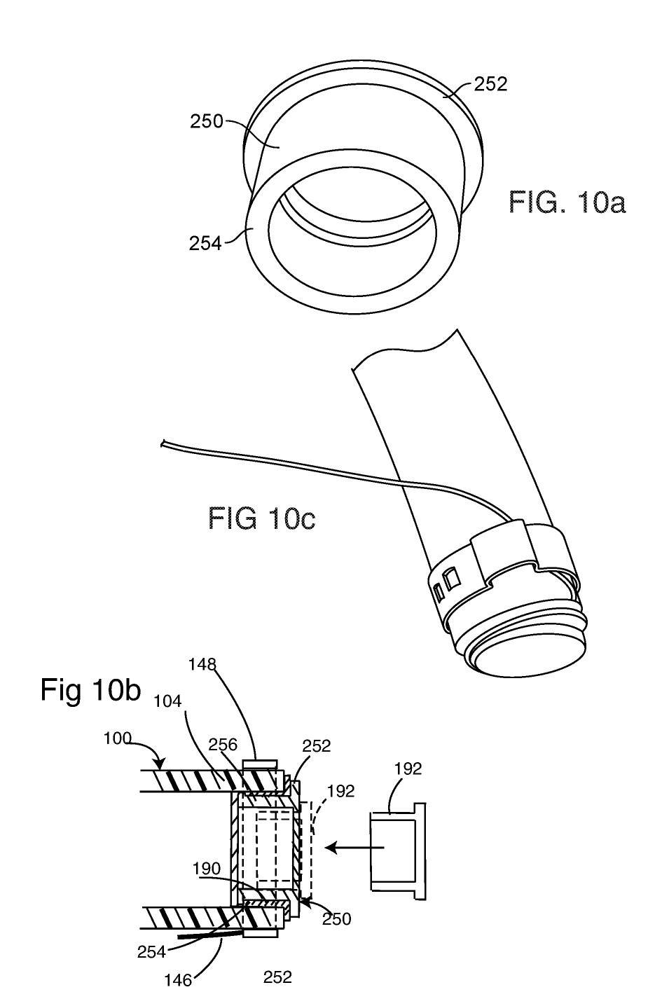

FIGS. 10-10c show the termination of a plastic outer tube 100 of constant diameter. A section of the tube is shown in FIG. 10. FIG. 10 shows the exit end 14 of a plastic tube 100. A hollow cylindrically shaped metal diffuser 250 having ends 252 and 254 is joined by a hollow body 156. Ends 252 and 254 are formed as flanges. The diffuser is shown in isolation in FIG. 10a. The inner diameter of the diffuser will approximate the inner diameter of a metal tube which, as mentioned above, is in the range of 25-28 mm. Prior to inserting the diffuser into tube 100, the screen 190 as shown in FIG. 10b is wrapped about end 254 of the diffuser and the diffuser 250 and screen 190 are pushed into the open end 104 of the tube 100. Thereafter, the cap 192 is inserted into the center of the diffuser; this orientation is shown in dotted line. A clamp 148 secures screen, cap, diffuser and rope. The sock 120 will assume the same orientation as shown in the other fires and has been eliminated in this FIG. 10b. FIG. 10c is an orthogonal view of the assembled end 104 of the tube.

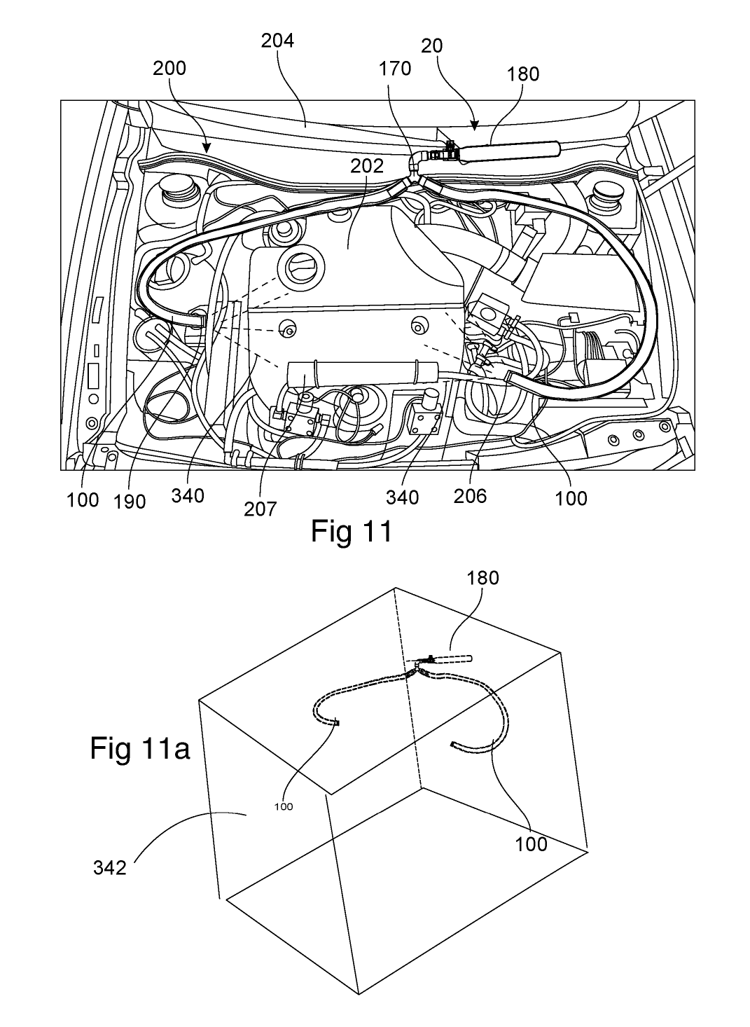

FIG. 11 shows an exemplary placement of the two-tube fire extinguishing system 20 with an engine compartment 200 of a vehicle. The illustrated engine compartment is typical of many vehicles and includes an engine 202, firewall 204, radiators 207 and other components. The fire retardant system 20 is positioned within the compartment 200. The gas generator 180 is secured to the firewall 204. Two tubes 100 are used in this exemplary system 20 and as illustrated both tubes are bent. Whether the tube is bent once or more times or is straight depends on the desired location of the exit ends 104 of each tube. FIG. 11a shows a fire extinguishing system in a cabinet.

The operation of the system is as follows: a) upon sensing a fire or the conditions for a fire an activation signal is generated to activate the gas generator 180. More particularly the activation signal is received by the igniter of the gas generator; b) gas is released by the gas generator 180 into the manifold 150 or 170 which in turn flows into the large open end 122 of the sock pocket 120. Reference is made to FIG. 6. In FIG. 6 the termination end 104 of tube 100 is not completely shown. Only the cap 192 is shown in the end 104 of the tube. As gas enters end 122 of the inner tube, hose or sock 120 it will tend to separate the two layers of material 230a and 230b quickly creating a flow path from end 122 to end 124 of the sock 120. With the pressurized gas at end 124 of the sock 120 the pressure gas pushes the cap or plug 192 out of the tube. The movement of the cap 192 away from the tube is shown by arrow 234. The gas will also flow out of the woven material forming the sock 120, see arrows 136, pushing the fire extinguishing material out the exit end 103 of each tube. The flow of the granules of fire extinguishing material is shown by the dotted lines 340 in FIG. 11. Reference is briefly made to FIG. 11a which shows the universal usage potential of the present invention. In FIG. 11a, the system 20 is located within or about a cabinet, building, storeroom, file cabinet, electronic storage cabinet, battery, transformer, server, library cabinet, museum glass shelf, medicine cabinet 342 and the like which is representative of all of the other spaces that may use the present invention.

Reference is again made to FIGS. 5, 7a and 7b as can be seen the internal or inner hose, tube sack or pocket 120 as well as the external flexible tube 100 or 100a terminate at the same outlet of the manifold 100 or 170. More particularly the inner tube or hose 120 is first placed upon the outlet and the external tube 100, 100a is placed over an end of the sack 120. In the following embodiment the inner tube or hose 120 and the external tube 100 are each individually terminated.

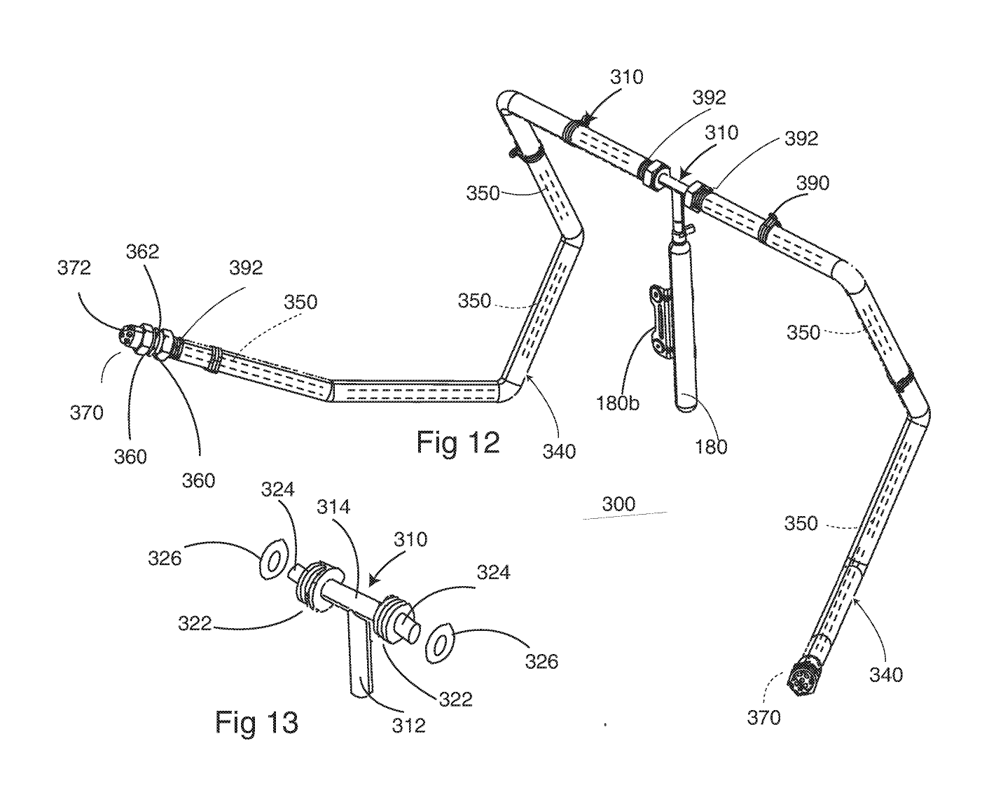

Reference is made to FIG. 12 which shows an alternate fire extinguishing system 300. The major components of this system include an inflator or gas generator 180, which is mounted using a bracket 180b to a convenient part of the vehicle such as the firewall (not shown). The inflator 180 is in fluid communication with a T-shaped manifold 310. The manifold includes a first tube 312 and a second or cross-tube 314. Tube 312 is connected to both the inflator and tube 314. Tube 314 has two ends 316 and 318. End 316 supports a hollow threaded connected 310 and end 318 supports another hollow threaded connector 322. The manifold 310 includes short tubes 324 each of which extends from the center of a respective threaded connector 320 and 322, each tube is in fluid communication with the cross-tube 314. A flat circular seal 326 is positioned about each tube 324 and rests up against a mating surface 328 of connectors 320, 322.

The other major components of this embodiment include one or more protective outer tubes or housings 340, much the same as tube 100, which protects one or more flexible, permeable inner tubes 350 (much the same as inner tube or hose 120) and fire extinguishing agent such as described above. In this alternative embodiment the tubes or housing are stainless steel corrugated tubes. A sampling of these corrugations is shown by numeral 341. One benefit if the corrugated shape is it can be bent into the desired shape easily. A plurality of brackets 390 may also be needed. Alternately, a solid plastic or metal pipe with the appropriate corner connects could be used. In the various figures, the curved sections of the pipe 342 can also be viewed as separate corner connectors. The permeable tube or hose 350 is also referred to as hose, tube, sock, pocket as used above. The tube 350 is mostly flat and is positioned in the protective tubes 340 as generally shown in FIGS. 2b and 6 as was tube 120. The system 300 further includes a number singled sided 360 and double sided 362 threaded couplings. Additionally, the system includes a nozzle 370 which includes at one end a single sided coupling 360. The nozzle includes a number of holes or outlets or orifices 372. As will be seen later the respective ends of each protective outer tube 340 includes a breakable seal 418 which prevents the agent from exiting the tube 340. Tube 340 is filled with the fire extinguishing agent, in the manner outer tube 100 was filled. The nozzle includes a pin 416 to assist in the breaking of the seal to enhance the rapid flow of fire extinguishing agent to quench the fire. As mentioned, a plurality of brackets 390 can be used to further secure the tubes 340 to an adjacent mounting surface.

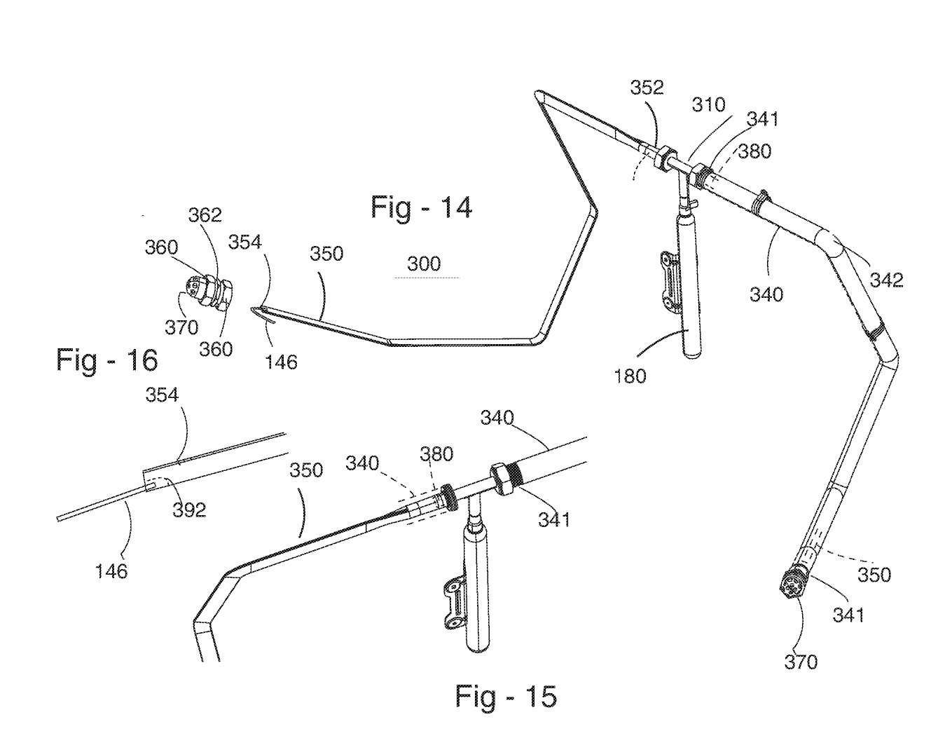

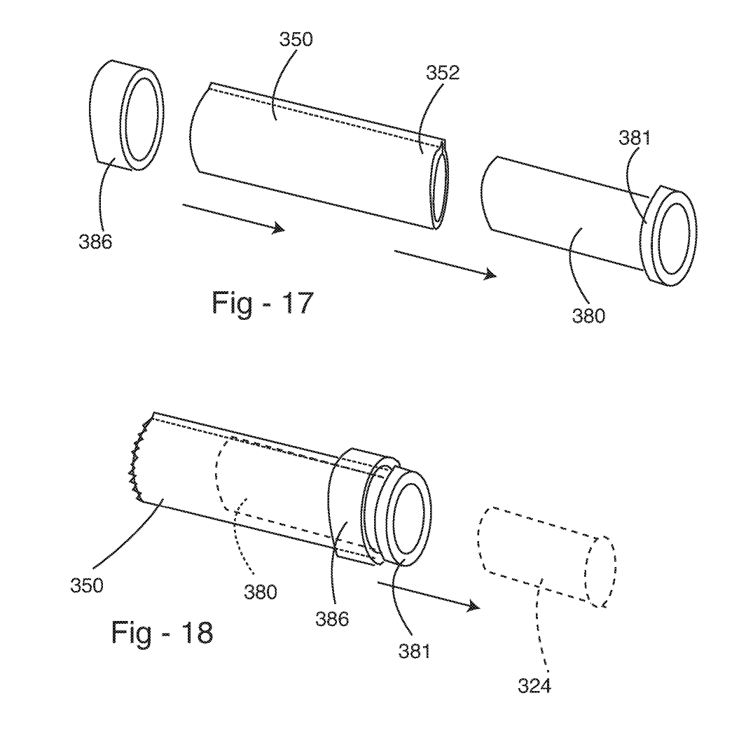

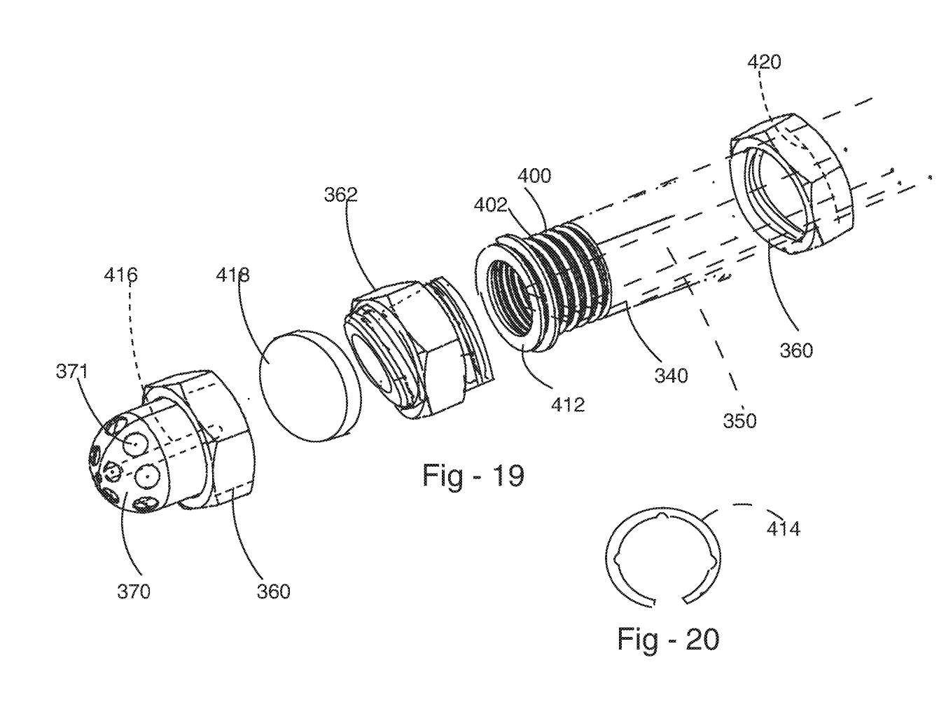

FIG. 14 is much the same as FIG. 12 but the left hand side tube 240 has been removed to reveal details of the internal, permeable tube, hose, sock, pocket 350. FIG. 14 also shows tube 350 on the left hand side as well as some of the couplings, inflator and nozzles. The internal, permeable tube 350 has a first end 352 and an opposite second end 354. Tube 350 when laid flat is preferably a flat tube. As can be seen in FIG. 14 end 352 is forced into a round configuration so it can be connected to a tube 324 of the manifold 310. This relationship is also shown in FIG. 15. In view of the high level of fluid pressure delivered at end 352 it is desirable to fasten end 352 to tube 324 in a secure manner. FIG. 17 shows end 352 of a segment of tube 350 positioned relative to a cylindrical, hollow connector (also called a tube liner) 380 which may include a larger diameter annular flange or lip 381. Numeral 382 shows a hollow end 382 of connector 380. Positioned near the segment of tube 250 is a crimp ring 386. The various arrows in FIG. 17 show how each of parts are moved together during assembly.

FIG. 18 shows the assembled configuration of the ring, hose and connector 380. In FIG. 18 the open end 352 of hose has been slipped onto the connector 380 and abuts the shoulder. Arrow 388 designates how the tube and tube liner are to be slipped upon the short tube 324 which is part of the manifold 310. Subsequently the crimp ring 386 is tightened securing the hose 350, tube liner 380 and crimp ring 386 to the manifold tube 324. The secured tube 352, tube liner 388 is also shown in FIGS. 14 and 15. As mentioned each tube 350 is basically flat and this carries through to its respective end 354. FIG. 16 shows end 354 of tube 350. While end 354 can be open, it is preferred the end be closed or partially closed. FIG. 16 shows end 354 being partially closed by a seam 392. With the tube partially open or fully open when the inflator is activated, pressurized gas is communicated rapidly to the end of tube 350 and then bears against the breakable seal. The rope or thread 146 is shown sewn or otherwise secured to the end 354 of the tube. The rope or thread 146 is used to position the flexible hose 350 in the exterior tube 344. Once the flexible tube has been inserted into the outer tube 340 the thread or rope 146 can be secured when the nozzle and its associated coupling 360 is secured to an end 394 of the exterior, perhaps corrugated tube. The terminal end of the hose 350 can also be seen near the terminal end 412.

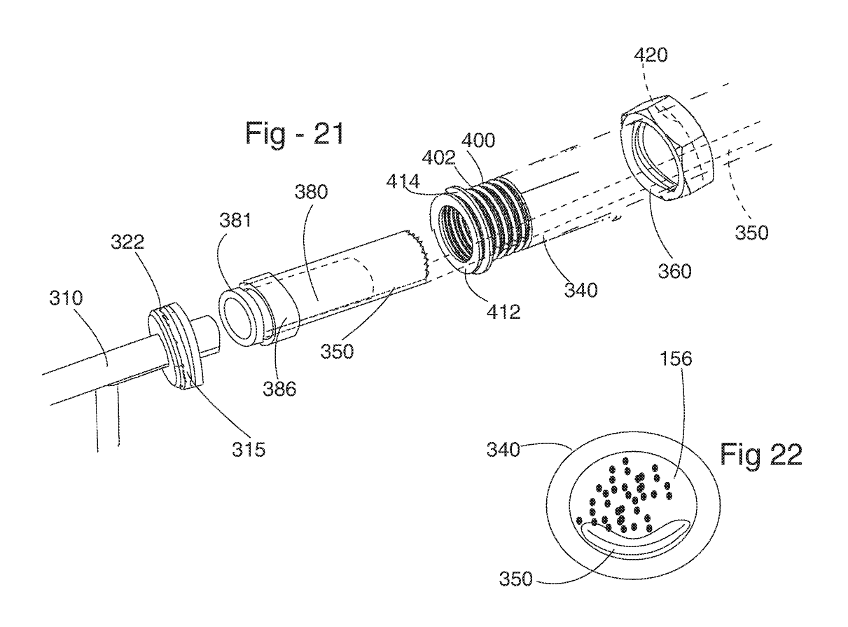

As mentioned in the embodiment shown in FIG. 12 the exterior tube or housing 340 is a corrugated tube and only some of the tube is shown as corrugated. A simple threaded connector/coupling is not suitable to join couplings to a corrugated pipe. FIG. 20 shows the various components at the nozzle end of the tube 340 and illustrates a typical connection of components to a corrugated tube. The tube 340 includes any number of adjacent hills 400 and valleys 402 (high points and low points). A single sided coupling 360 is slipped upon a terminal end 412 of the tube 340 as shown in FIG. 20. A segmented ring or washer 414 is manipulated so it can be placed into a valley 402. A double side coupling 362 is placed against the end 412 and the singled sided couple connected to a facing face of the threads of connector 362 and tightened, creating a fluid tight joint at end 412 with the segmented ring sandwiched between the shoulder 420 of the single sided coupling 360 and the end of the facing threads. The single side coupling associated with the nozzle 370 is secured to the facing face of the threads of the double sided coupling 362 with the breakable seal sandwiched therebetween. If the seal is sufficiently flexible when the tube 340 is pressurized the seal may break under pressure releasing the fire retarding agent 160 or upon contact with the end of pin 416. FIG. 21 shows how the manifold 310 is secured to the manifold end of the hose 340. As before a segmented ring 414 and a single sided coupling 369 are used. The single sided coupling is secured to the threads 315 of the threaded connector 322. The segmented ring is sandwiched between the shoulder 420 and flat end of the threaded connector 322.

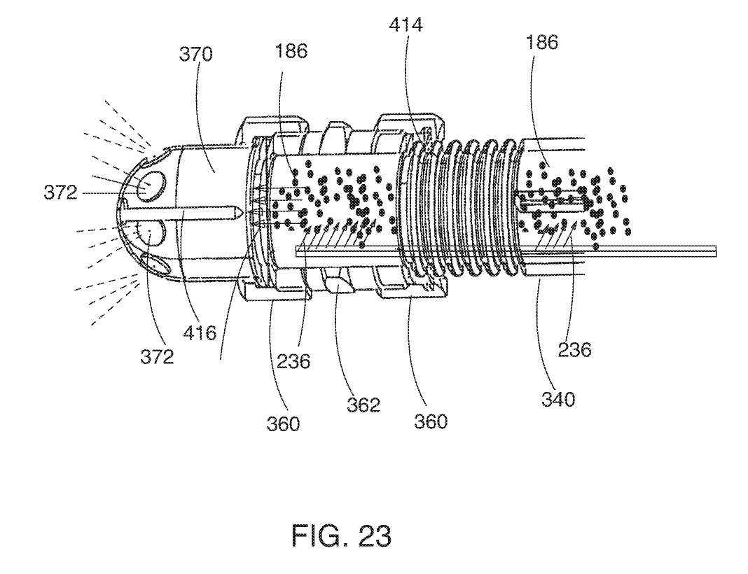

FIG. 22 is a cross-sectional view through the tube and the flattened tube 350 showing the agent 160 and is much the same as FIG. 6a. FIG. 23 is a cross-sectional view running along the longitudinal axis of tube 340 and in addition to the nozzle 370 and couplings 360 and 362 shows the fire extinguishing agent 160 located upon the flat length of tube 350. The arrows 430 represent the inflation gas received from the inflator 180. The arrows 432 show the gas if permitted to flow through the permeable tube 350 and pressurize the interior of tube 340 At a determinable level of pressure the breakable seal 418 bursts permitting the agent to flow out of the nozzle. The arrow 434 shows the pressure of the gas pressuring upon the breakable burst disk 418. The arrows 436 show the agent exiting the nozzle.

Many changes and modifications in the above-described embodiment of the invention can, of course, be carried out without departing from the scope thereof. Accordingly, that scope is intended to be limited only by the scope of the appended claims.

1. A system (20. 300) including a fire extinguishing apparatus capable of delivering a high velocity stream of fluid and fire extinguishing agent, both the fluid and agent directed toward the fire, the apparatus comprising:
at least an outer first tube (100,340) having a first end (352) and a second end (354), the first tube have a predetermined length L, inner diameter and outer diameter,
an air permeable second tube or hose or sack (120, 350) positioned inside of the first tube, the sack having a first tube end and a second tube end; the sack extending from a first position along outer first tube end to a second position along the outer first tube and terminating close to or at the second end of the outer first tube;
the fire extinguishing agent (160) located between the sack and the inner diameter of the first tube;
a dislodgable plug or burst disk (190, 370) secured to the second end of the first tube to prevent contaminants from entering the first tube;
a source of high pressure (180) fluid connected directly or indirectly such as through a manifold to the first end of the first tube, the source configured to deliver the high pressure fluid upon receipt of an activation signal causing pressurizing fluid to enter the first end of the inner tube or sack, the fluid flow causing the plug to dislodge or disk to break and flowing out of the sack to push the fire extinguishing material out the now open second end of the first tube.

2. The system according to claim 1 wherein the fluid flow from the permeable second hose, tube or sack (120, 350) is along a length of the second tube or hose or sack.

3. The system according to claim 1 wherein the high pressure fluid is a gas or fluid of one of argon or helium or nitrogen, carbon dioxide or a combination thereof.

4. The system according to claim 1 further including a second inner tube that is operatively connected to the source of high pressure fluid and with a second outer tube having a fire extinguishing agent therein, an end of the second outer tube temporarily plugged by another plug (190) or breakable disk (418).

5. The system according to claim 1 wherein the first outer tube is a corrugated tube (340) and wherein a ring or washer is positioned in one of the corrugations near an end of the first outer tube and wherein a first coupling is positioned behind the ring or washer, the first coupling is configured to be secured to a second coupling associated with the manifold or with the exit end of the first outer tube and wherein with the first and second coupling secured together a fluid tight seal is created between the couplings, the ring or washer and an exterior surface of the corrugated tube.

6. The system according to claim 1 wherein the second coupling (322, 362) at an exit end of the outer tube is configured to connect to a nozzle (370) having a plurality of openings (370) to permit the fluid to flow therethrough.

7. The system according to claim 1 wherein the breakable disk is located between the nozzle and the second coupling.

8. The system according to claim 1 wherein the nozzle includes a pin and end of which is positioned in proximity with the breakable disk, the pin configured to break the breakable disk.

9. The system according to claim 4 wherein the first tube and the second tube are straight or curved and extend from the source in the same or different direction.

10. The system according to claim 1 wherein the source of high pressure fluid is a pyrotechnically activated gas generator.

11. The system according to claim 1 wherein the first tube is one of plastic, iron, and corrugated metal or plastic.

12. The system according to claim 1 wherein the system is fixedly located within some space capable of supporting a fire including an engine or storage compartment.

13. The system according to claim 1 wherein the fire extinguishing agent is a powder.

14. The system according to claim 13 further including a desiccant.

15. The system according to claim 1 wherein the fire extinguishing agent is dry powder silicon added for a hydrophobic effect.

16. The system according to claim 1 including a screen at the second end of the first tube and also at the end of any other similar tube.

17. A method of extinguishing an existing fire or an anticipated fire within a space comprising the steps of:
a) sensing the fire or anticipated fire and generating an activation signal indicative of this happening;
b) placing within the space prior to the fire, a fire extinguishing system comprising a source of high pressure fluid, one or more tubes, an air permeable inner tube or hose in each outer tube, and a quantity of fire extinguishing agent located between an exterior surface of the inner hose, tube or sock and an inner diameter of the one or more outer tubes;
c) activating the source of pressurized fluid in correspondence of sensing the fire or anticipated fire;
d) directing a high velocity stream of fluid out into a first end of the sock to force the gas extinguishing material out of each tube to extinguish the fire or prevent the starting of a fire.

18. The system according to claim 1 wherein the primary constituent of the fire extinguishing agent is ammonium phosphate.
